(19) United States
(12) Patent Application Publication
(10) Pub. No.: US 2017/0134661 A1
(43) Pub. Date: May 11, 2017

(54) DRIVING SUPPORT APPARATUS, DRIVING SUPPORT METHOD, IMAGE CORRECTION APPARATUS, AND IMAGE CORRECTION METHOD

(71) Applicant: DENSO CORPORATION, Kariya-city, Aichi-pref. (JP)

(72) Inventors: Hikumetsuto Chietein, Kariya-city (JP); Muneaki Matsumoto, Kariya-city (JP); Hitoshi Tanaka, Kariya-city (JP)

(21) Appl. No.: 15/318,641

(22) PCT Filed: Jun. 8, 2015
(86) PCT No.: PCT/JP2015/002862

§ 371 Date: Dec. 13, 2016

(30) Foreign Application Priority Data
Jun. 18, 2014 (JP) 2014-124874

(51) Int. Cl. H04N 5/232; H04N 7/18; G08G 1/16; B60R 1/00

(52) U.S. Cl. CPC H04N 5/23293; B60R 1/002; H04N 7/183; H04N 5/23238; H04N 7/188; G08G 1/16; B60R 2300/102; B60R 2300/105; B60R 2300/607; B60R 2300/303; B60R 2300/804; B60R 2300/8093; G06K 9/00805

(57) ABSTRACT

A driving support apparatus is arranged at a vehicle attached with a vehicle-mounted camera at a predetermined angle to execute driving support based on an image taken by the vehicle-mounted camera. The driving support apparatus includes: a height sensor that is attached at locations of the vehicle and detects a vehicle height at a location where the height sensor is attached; an attitude detector that detects an attitude of the vehicle based on a detection result of the height sensor; an acquisition device that acquires an image taken by the vehicle-mounted camera; a correction device that corrects the image acquired by the acquisition device based on the attitude of the vehicle detected by the attitude detector; and an execution device that executes driving support based on the image corrected by the correction device.

### CROSS REFERENCE TO RELATED APPLICATION

This application is based on Japanese Patent Application No. 2014-124874 filed on Jun. 18, 2014, the disclosure of which is incorporated herein by reference.

### TECHNICAL FIELD

The present disclosure relates to technology that supports driving based on an image taken by a vehicle-mounted camera.

### BACKGROUND ART

It has been known that conventional technology uses a vehicle-mounted camera to take photos at the surrounding of a vehicle to execute driving support based on the photos taken. For example, the technology for monitoring the lane departure of the vehicle by photographing lane marks painted on a road through the vehicle-mounted camera and informing a driver in a situation where the vehicle departs from the lane mark; and the technology for providing a plurality of vehicle-mounted cameras facing in different directions and displaying images respectively taken by the plurality of vehicle-mounted cameras and converting to a plurality of bird's eye view images viewed the vehicle from the top and further combining the plurality of bird's eye view images to display an image of the surrounding of the vehicle viewed from the top, have been known (for example, see Patent Literature 1)

With regard to this kind of technology, when a target object such as a lane mark or another vehicle is taken by the vehicle-mounted camera, driving support is executed based on the position of the target object within the taken image (the position in the image). Accordingly, it is needed to take a relative position, which is predetermined among relative positions from the vehicle. The mounting position or mounting angle (attitude) of a vehicle-mounted camera is preliminarily adjusted so that the predetermined relative position can be filmed.

However, for the above prior art, it raises difficulty in that the driving support cannot be properly carried out when the predetermined relative position cannot be filmed even when the attitude of the vehicle-mounted camera is preliminarily adjusted. In other words, even when the adjustment of the attitude of the vehicle-mounted camera is carried out, the attitude of the vehicle changes as the load exerted on the vehicle changes with a passenger boarding on the vehicle and carrying load. Therefore, the attitude of the vehicle-mounted camera also changes. In this situation, since the predetermined relative position cannot be filmed, it is difficult to properly execute the driving support.

### PRIOR ART LITERATURES

### Patent Literature

Patent Literature 1: JP 2012-175314A

### SUMMARY OF INVENTION

It is an object of the present disclosure to provide technology that properly executes driving support based on an image taken by a vehicle-mounted camera.

To achieve the above-mentioned object, with regard to a first aspect of the present disclosure, a driving support apparatus is arranged at a vehicle attached with a vehicle-mounted camera at a predetermined angle to execute driving support based on an image taken by the vehicle-mounted camera. The apparatus includes: a height sensor that is attached at a plurality of locations of the vehicle and detects a vehicle height at a location where the height sensor is attached; an attitude detector that detects an attitude of the vehicle based on a detection result of the height sensor; an acquisition device that acquires the image taken by the vehicle-mounted camera; a correction device that corrects the image acquired by the acquisition device based on the attitude of the vehicle detected by the attitude detector; and an execution device that executes the driving support based on the image corrected by the correction device.

In a second aspect of the present disclosure, a driving support method executes driving support based on an image taken by a vehicle-mounted camera attached to a vehicle at a predetermined angle. The method includes: detecting an attitude of the vehicle based on a detection result of a height sensor; acquiring an image taken by the vehicle-mounted camera; correcting the acquired image based on the attitude of the vehicle; and executing driving support based on the corrected image.

In a third aspect of the present disclosure, an image correction apparatus is arranged at a vehicle attached with a vehicle-mounted camera at a predetermined angle to correct an image taken by the vehicle-mounted camera. The apparatus includes: a height sensor that is attached at a plurality of locations of the vehicle and detects a vehicle height at a location where the height sensor is attached; an attitude detector that detects an attitude of the vehicle based on a detection result of the height sensor; an acquisition device that acquires an image taken by the vehicle-mounted camera; and a correction device that corrects the image acquired by the acquisition device based on the attitude of the vehicle detected by the attitude detector.

In a fourth aspect of the present disclosure, an image correction method corrects an image taken by a vehicle-mounted camera attached to a vehicle at a predetermined angle. The method includes: detecting an attitude of the vehicle based on a detection result of a height sensor; acquiring the image taken by the vehicle-mounted camera; and correcting the acquired image based on the attitude of the vehicle.

With regard to the apparatuses according to the first and third aspects of the present disclosure and the methods according to the second and fourth aspects of the present disclosure, since the attitude of the vehicle is detected based on the detection result of the height sensor, the attitude of the vehicle (or the attitude of the camera) changed with the load applied to the vehicle can be detected. Subsequently, the image taken by the vehicle-mounted camera is corrected based on the attitude of the vehicle to execute driving support based on the corrected image. Accordingly, the driving support based on the image taken by the vehicle-mounted camera can be properly executed.

### BRIEF DESCRIPTION OF DRAWINGS

The above and other objects, features and advantages of the present disclosure will become more apparent from the following detailed description made with reference to the accompanying drawings. In the drawings:

FIGS. 1A and 1B are explanatory drawings that illustrate a driving support apparatus;

FIG. 2 is a flowchart that illustrates a synthetic image display process carried out by a controller;

FIG. 3 is an explanatory drawing that illustrates a synthetic image without defect;

FIG. 4 is an explanatory drawing that illustrates a synthetic image with defect;

FIG. 5 is a flowchart that illustrates a camera attitude detection process carried out by the controller;

FIGS. 6A and 6B are explanatory drawings that conceptually illustrate the attitude contents of vehicle-mounted cameras;

FIGS. 7A and 7B are explanatory drawings that conceptually illustrate a method for detecting a roll change amount and a pitch change amount of the vehicle-mounted cameras;

FIGS. 8A and 8B are explanatory drawings that conceptually illustrate a method for detecting a roll change amount and a pitch change amount of the vehicle-mounted cameras;

FIGS. 9A and 9B are explanatory drawings that conceptually illustrate a method for detecting a roll change amount and a pitch change amount of the vehicle-mounted cameras in a situation where a vehicle is not a rigid body;

FIGS. 10A and 10B are explanatory drawings that conceptually illustrate a method for detecting a roll change amount in vertical position and a pitch change amount of the vehicle-mounted cameras;

FIG. 11 is a flowchart that illustrates a camera attitude detection process carried out by a controller in a modification example; and

FIG. 12 is a flowchart that illustrates a camera attitude detection process to be executed in addition to the camera attitude detection process described above.

### EMBODIMENTS FOR CARRYING OUT INVENTION

The following describes an embodiment of a driving support apparatus for clearly illustrating an invention of the present application described above.

### A: Apparatus Configuration

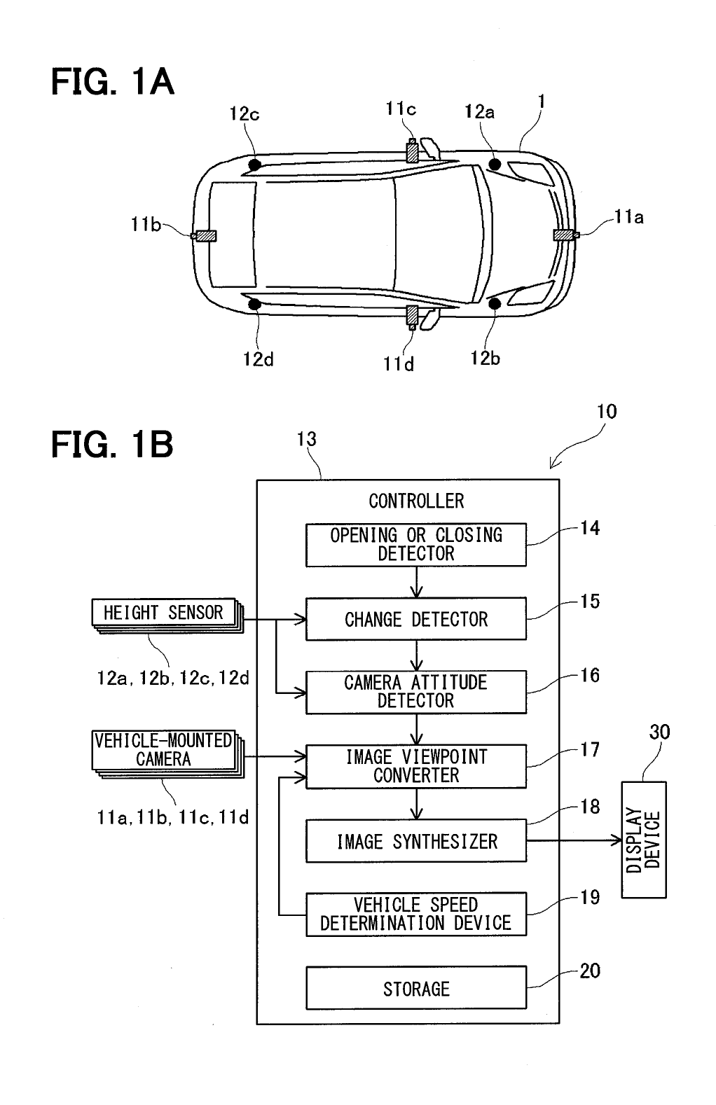

FIGS. 1A and 1B illustrate the configuration of a driving support apparatus 10 arranged in a vehicle 1. FIG. 1A conceptually illustrates the arrangement positions for the vehicle-mounted cameras 11a to 11d and the height sensors 12a to 12d included in the driving support apparatus 10. As shown in FIG. 1A, the vehicle-mounted cameras 11a to 11d are arranged at front, rear, left and right of the vehicle 1 respectively in the driving support apparatus 10 in the present embodiment. The installation positions and the installation angles for these vehicle-mounted cameras 11a to 11d are adjusted so as to make these vehicle-mounted cameras 11a to 11d to film road surface sides (mutually different relative positions from the vehicle) at front, rear, left and right of the vehicle 1 respectively. In addition, height sensors 12a to 12d are arranged respectively at left and right in the front and rear parts of the vehicle 1. It is possible that these height sensors 12a to 12d detect the vehicle height of the vehicle 1 at the positions where these cameras are attached. It is noted that an indirect-type height sensor for using vertical displacement amount of the suspension arm relative to the vehicle body or a direct-type height sensor for directly measuring the distance with respect to a road surface with ultrasound or laser may be used for the height sensors 12a to 12d.

FIG. 1B conceptually illustrates the controller 13 collaborating with the vehicle-mounted cameras 11a to 11d and the height sensors 12a to 12d in the driving support apparatus 10 in the present embodiment. The controller 13 has a circuit board on which a CPU, memory or a variety of controllers are mounted, and is arranged at the back side of the instrument panel in the front of a driver seat.

When the interior of the controller 13 is classified into functional blocks having the respective functions, the controller 13 includes: an opening or closing detector 14 for detecting opening or closing of the door or trunk of the vehicle 1; a change detector 15 for detecting whether the attitudes of the vehicle-mounted cameras 11a to 11d have been changed over the predetermined amount based on the vehicle heights detected by the height sensors 12a to 12d; a camera attitude detector 16 for detecting the attitudes of the vehicle-mounted cameras 11a to 11d based on the vehicle heights detected by the height sensors 12a to 12d; an image viewpoint converter 17 for converting viewpoint (performing coordinate conversion) on images around the vehicle filmed by the vehicle-mounted cameras 11a to 11d to the images viewed from the top of the vehicle 1 respectively; an image synthesizer 18 for synthesizing the images which have been processed under viewpoint conversion to display on the display device 30; a vehicle speed determination device 19 for determining the speed of the vehicle 1; and a storage 20 for storing a variety of data or programs.

For the display device, a liquid crystal display device may be arranged in the instrument panel in the front of the driver seat. In addition, the camera attitude detector 16 corresponds to an “attitude detector” in the present disclosure; the image viewpoint converter 17 and the storage 20 correspond to an “acquisition device” in the present disclosure; the image viewpoint converter 17 corresponds to a “correction device” in the present disclosure; and the image synthesizer 18 and the display device 30 correspond to an “driving support execution device” in the present disclosure. Moreover, the controller 13 corresponds to an “image correction apparatus”.

The following describes the process executed in the above-mentioned driving support apparatus 10. Firstly, the following describes the “synthesized image display process” for displaying the images viewing the surrounding situation of the vehicle 1 from the top on the display device 30.

### B. Process Executed in the Driving Support Apparatus 10

B-1. Synthesized Image Display Process:

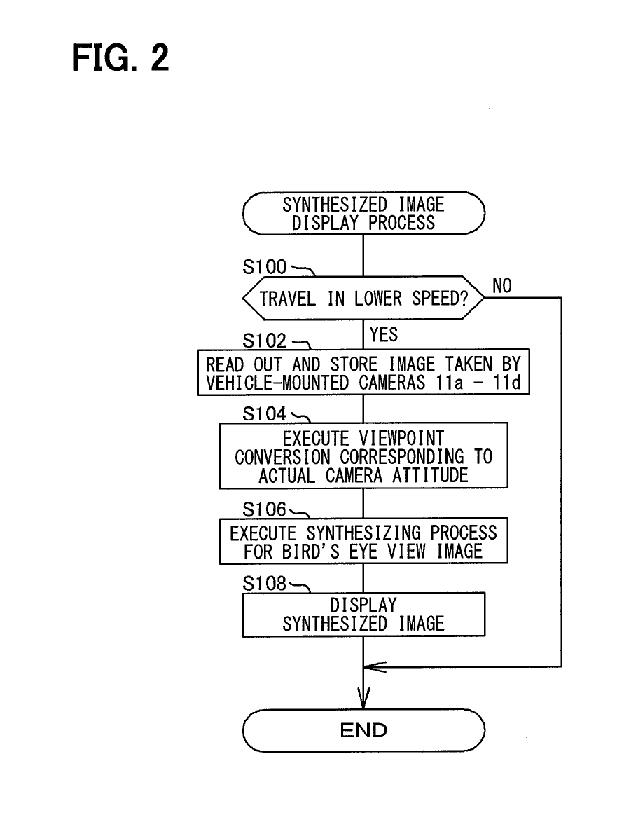

FIG. 2 illustrates a flowchart of the synthesized image display process carried out in the driving support apparatus 10 in the present embodiment. It is noted that the process executed in the driving support apparatus 10 in the present embodiment is actually carried through the CPU inside the controller 13 executing programs stored in ROM; however, the following describes the controller 13 and the above-mentioned functional blocks 14 to 20 as the execution subjects. Additionally, the synthesized image display process is repetitively carried out (for example, at every 1/60 second) as a timer interruption process after an ACC power source is turned on.

When the synthesized image display process illustrated in FIG. 2 is started, the vehicle speed determination device 19 in the controller 13 determines whether the vehicle 1 is travelling in a lower speed (at S100). For example, it is determined whether the vehicle speed is less than or equal to 100 Km/h based on the vehicle pulse sent from a vehicle speed sensor (not shown). When the vehicle 1 is determined not travelling in a lower speed (S100: no) based on the result of the determination process at S100, the synthesized image display process illustrated in FIG. 2 is completed. Herein, the synthesized image display process illustrated in FIG. 2 is a process that displays the situation of a region adjacent to the vehicle 1 as part of the surrounding of the vehicle 1. Accordingly, when the vehicle 1 is not travelling in a lower speed, since the driver cannot obtain useful information even when the situation of the region adjacent to the vehicle is displayed and switched instantaneously, the synthesized image display process illustrated in FIG. 2 is completed.

In contrast, when the vehicle 1 is travelling in a lower speed (S100: yes), the image viewpoint converter 17 reads out the images (hereinafter referred to as “filmed images”) respectively filmed by the vehicle-mounted cameras 11a to 11d from the vehicle-mounted cameras 11a to 11d, and once stores the filmed images in the storage 20 (at S102). Then, the filmed images stored in the storage 20 are respectively processed by viewpoint conversion (coordinate conversion) that are converted to the images (bird's eye view images) viewed from the top of the vehicle 1 in correspondence to the attitudes of the vehicle-mounted cameras 11a to 11d (in view of the attitudes of the vehicle-mounted cameras 11a to 11d) (at S104).

It is noted that the ideal attitude used in the following refers to a design value for installing the vehicle-mounted cameras 11a to 11d; and the attitude at delivery timing refers to an actual measurement value at the timing of installing the vehicle-mounted cameras 11a to 11d (at the timing of delivery), and these values indicate the attitudes of the vehicle-mounted cameras 11a to 11d relative to the vehicle. In contrast, the actual attitude (temporary attitude) is an actual value related to the attitudes of the vehicle-mounted cameras 11a to 11d after the change in load applied to the vehicle 1, and this value indicates the attitude of the vehicle-mounted cameras 11a to 11d relative to a road surface.

Although the installation positions or installation angles of the vehicle-mounted cameras 11a to 11d are adjusted before delivering the vehicle 1, it is difficult to install the vehicle-mounted cameras 11a to 11d at the ideal attitude (for example, design value such as less than one degree from an ideal roll or pitch). Therefore, the attitudes of the respective vehicle-mounted cameras 11a to 11d at the timing of delivery are preliminarily stored in the storage 20 before the timing of delivering the vehicle 1. Them, at step S104, a bird's eye view image, which corresponds to each of the vehicle-mounted cameras 11a to 11d, at each of four sides of the vehicle 1 is generated by performing viewpoint conversion (viewpoint conversion in view of the attitudes at the timing of delivery) corresponding to the actual attitudes of the vehicle-mounted cameras 11a to 11d. Thus, when a bird's eye view image taken at four sides of the vehicle 1 is generated (at S104), the image synthesizer 18 displays an image (hereinafter referred to as a “synthesized image”), which synthesizes these images, on the display device 30. Thus, when the synthesized image is displayed on the display device 30, the synthesized image display process illustrated in FIG. 2 is terminated.

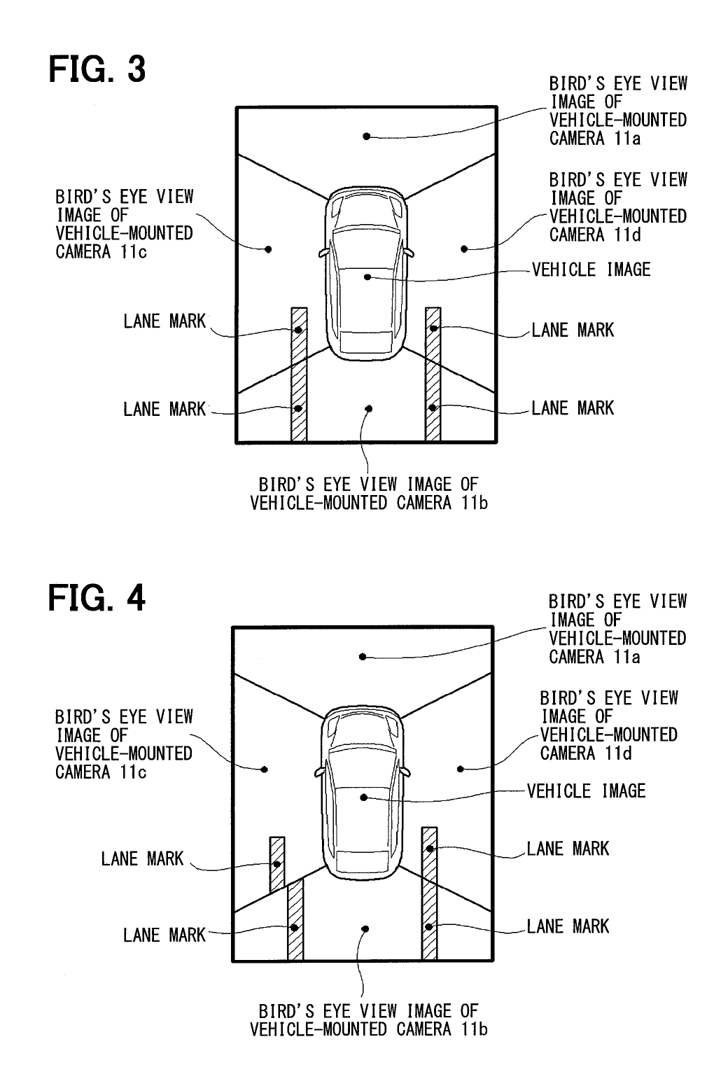

FIG. 3 shows an example of a synthesized image displayed at step S108. As shown in FIG. 3, in the synthesized image of the present embodiment, “a vehicle image viewed from the top of the vehicle” is displayed at the center of the display device 30; a bird's eye view image taken by the vehicle-mounted camera 11a is displayed at the front side of the vehicle image; a bird's eye view image taken by the vehicle-mounted camera 11b is displayed at the rear side of the vehicle image; a bird's eye view image taken by the vehicle-mounted camera 11c is displayed at the left side of the vehicle image; and a bird's eye view image taken by the vehicle-mounted camera 11d is displayed at the right side of the vehicle image.

In the example of the synthesized image illustrated in FIG. 3, the lane mark appeared at the left of the rear side of the vehicle 1 is taken across the bird's eye view image of the vehicle-mounted camera 11b and the bird's eye view image of the vehicle-mounted camera 11c. In the example of this synthesized image, the lane mark is displayed without deviation at the junction of the bird's eye view image of the vehicle-mounted camera 11b and the bird's eye view image of the vehicle-mounted camera 11c. This generates the respective bird's eye view images by storing the attitudes of the vehicle-mounted cameras 11a to 11d (in this case, vehicle-mounted cameras 11b, 11c) at the time of delivery before delivering the vehicle 1 and performing viewpoint conversion corresponding to the actual attitudes.

Similarly, the lane mark appeared at the right of the rear side of the vehicle 1 is taken across the bird's eye view image of the vehicle-mounted camera 11b and the bird's eye view image of the vehicle-mounted camera 11d In the example of this synthesized image, the lane mark is displayed without deviation at the junction of the bird's eye view image of the vehicle-mounted camera 11b and the bird's eye view image of the vehicle-mounted camera 11d This generates the respective bird's eye view images by storing the attitudes of the vehicle-mounted cameras 11a to 11d (in this case, vehicle-mounted cameras 11b, 11d at the time of delivery before delivering the vehicle 1 and performing viewpoint conversion corresponding to the actual attitudes.

In the driving support apparatus 10 of the present embodiment described above, the actual attitudes of the vehicle-mounted cameras 11a to 11d before delivering the vehicle 1 are stored in the storage 20 so that the offset of the images is not caused at the bird's eye view images taken by the vehicle-mounted cameras 11a to 11d. Even when the attitudes of the vehicle-mounted cameras 11a to 11d at the timing of delivery prior to the delivery of the vehicle 1, there is a change in the attitudes of the vehicle-mounted cameras 11a to 11d (actual attitudes) after the delivery of the vehicle 1. That is, subsequent to the delivery of the vehicle 1, when a passenger boards on vehicle 1 and the baggage is put in the vehicle 1, the attitude of the vehicle 1 changes as the load applied to the vehicle 1 changes. Accordingly, the attitudes of the vehicle-mounted cameras 11a to 11d also change. Regardless of a change in the attitudes of the vehicle-mounted cameras 11a to 11d, when the bird's eye view image is generated so as to correspond to the stored attitudes of the vehicle-mounted cameras 11a to 11d at the timing of delivery prior to the delivery of the vehicle 1, it is possible that the offset in the image appears in the bird's eye view images taken by the vehicle-mounted cameras 11a to 11d. For example, as shown in FIG. 4, the lane mark filmed in the bird's eye view image taken by the vehicle-mounted camera 11c and the lane mark filmed by the bird's eye view image taken by the vehicle-mounted camera 11b are mutually displayed with an offset although they are the same lane mark.

In the driving support apparatus 10 of the present embodiment, when it is detected that the load (hereinafter referred to as “carrying load”) applied to the vehicle 1 caused by the passenger or carrying baggage is confirmed, the attitude of the vehicle 1 changed by the load, that is, the actual attitudes of the vehicle-mounted cameras 11a to 11d are newly detected. In other words, the attitudes of the vehicle-mounted cameras 11a to 11d stored in the storage 20 are corrected. In the following, the “camera attitude detection process” for detection (or correcting) the actual attitudes of the vehicle-mounted cameras 11a to 11d along with the confirmation of the “carrying load” is described.

B-2. Camera Attitude Detection Process:

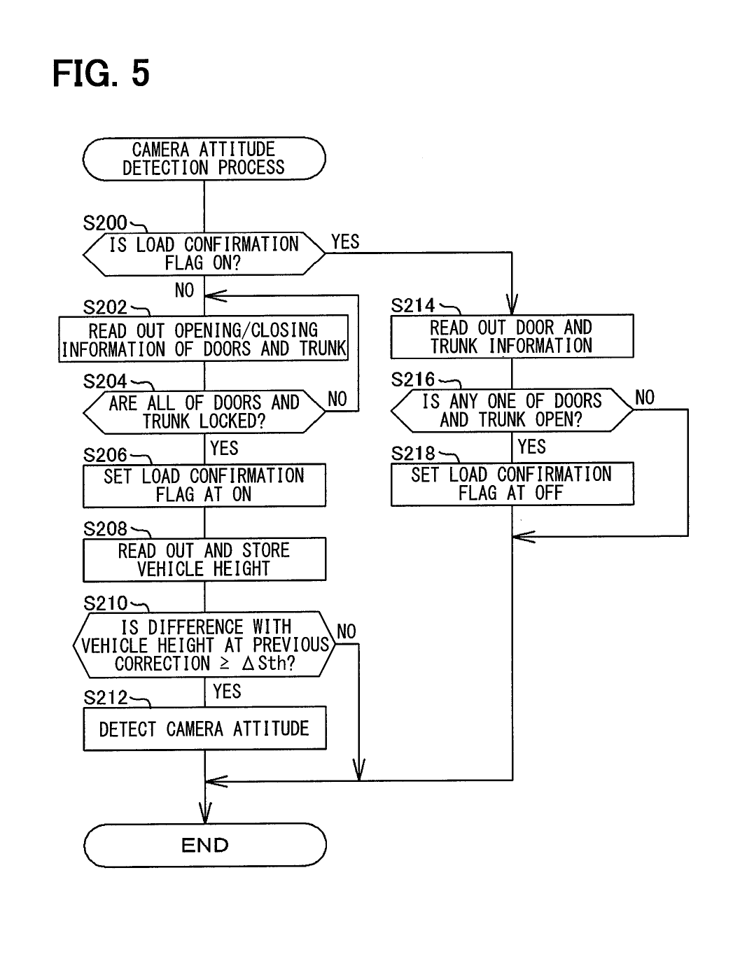

FIG. 5 illustrates a flowchart of the camera attitude detection process carried out in the driving support apparatus 10 of the present embodiment. This camera attitude detection process is repetitively executed (at, for example, every 1/60 second) as a timer interruption process after the ACC power source is turned on.

When the camera attitude detection process illustrated in FIG. 5 starts, the controller 13 firstly determines whether a load confirmation flag is set to ON (at S200). The load confirmation flag is a flag that indicates the above-mentioned “the load (carrying load) applied to the vehicle 1 caused by the passenger or carrying baggage having been already confirmed, and its storage region in the predetermined address of the storage 20 is ensured. Accordingly, in the determination process at step S200, it is surely determined whether “carrying load” has been already confirmed or not.

When it is determined that “carrying load” has not been confirmed based on the result of the determination process at step S200 (S200: no), then the opening or closing detector 14 reads out the information (opening/closing information) about whether the door or trunk of the vehicle 1 is open or not (at step S200). For example, an “opening or closing signal” sent from a sensor for detecting opening or closing of the door or trunk such as a courtesy switch is received. Then, the information (opening or closing information) about whether the door or trunk is open or not is read out. Subsequently, when the opening or closing information is read out (at S202), it is determined whether all of the doors and trunk of the vehicle 1 are locked or not (at S204).

When it is determined that all of the doors and trunk of the vehicle 1 have not been locked (one of them is still open) based on the result of the determination process at S204 (S204: no), the processes at S202 and S204 are repetitively processed. That is, it is in an idle state until all of the doors and trunk of the vehicle 1 are all locked.

When all of the doors and trunk of the vehicle 1 are locked (S204: yes), the load confirmation flag is set at ON (at S206).

Herein, when all of the doors and trunk of the vehicle 1 are locked, it is estimated that all of the passengers are on board and all of the baggage is carried when travelling of the vehicle 1 starts. In other words, it is estimated that “carrying load” is confirmed. Therefore, when all of the doors and the trunk of the vehicle 1 are locked (S204: yes), the load confirmation flag is set at ON (at S206). In addition, along with the confirmation of “carrying load”, it is estimated that the attitude of the vehicle 1 is confirmed and the actual attitudes of the vehicle-mounted cameras 11a to 11d are also confirmed. After the load confirmation flag is set at ON (at S206), the process for correcting (or detecting) the actual attitudes of the vehicle-mounted cameras 11a to 11d is carried out (at S208 to S212).

In this process, firstly, the change detector 15 determines whether the attitude changes over the predetermined amount from a time point (at a time point where “carrying load” is confirmed) of detecting (or correcting) the actual attitudes of the vehicle-mounted cameras 11a to 11d in a previous occasion. Specifically, the vehicle heights (at the respective positions) detected by the height sensors 12a to 12d are read out, and these vehicle heights are stored in the storage 20 (at S208). Subsequently, “the vehicle height read out at a present occasion” and “the vehicle height at the timing of detecting or correcting the actual attitudes of the vehicle-mounted cameras 11a to 11d in a previous occasion” are compared by the respective height sensors 12a to 12d (at S210). As a result, when a difference between “the vehicle height read out at a present occasion” and “the vehicle height at the timing of detecting or correcting the actual attitudes of the vehicle-mounted cameras 11a to 11d in a previous occasion” is over the predetermined threshold value ΔSth based on the results of one or more of the height sensors 12a to 12d (S210: yes), it is determined that the actual attitudes of the vehicle-mounted cameras 11a to 11d have been changed over a predetermined amount. In other words, when at least one of the vehicle heights has been changed over ΔSth based on the positions where the height sensors 12a to 12d are arranged, since the attitude of the vehicle has been changed in a certain degree, it is determined that the actual attitudes of the vehicle-mounted cameras 11a to 11d also have been changed over a predetermined amount along with this situation.

It is noted that when the process at S210 is carried out after the ACC power source is turned on, when “the vehicle height at the timing of detecting the actual attitudes of the vehicle-mounted cameras 11a to 11d in a previous occasion” is not stored, the vehicle height stored at the storage 20 prior to delivery is set to be “the vehicle height at the timing of detecting the actual attitudes of the vehicle-mounted cameras 11a to 11d in a previous occasion”.

When it is determined that the actual attitudes of the vehicle-mounted cameras 11a to 11d have been changed over the predetermined amount based on the result of the determination process at S210 (S210: yes), the camera attitude detector 16 detects the current actual attitudes of the vehicle-mounted cameras 11a to 11d by detecting the current attitude of the vehicle based on the vehicle heights detected by the height sensors 12a to 12d (at S212). The detected actual attitudes of the vehicle-mounted cameras 11a to 11d are stored in the storage 20. Accordingly, the actual attitudes of the vehicle-mounted cameras 11a to 11d to be reflected (or considered) in the viewpoint conversion process (at S104) illustrated in FIG. 2 are corrected. It is noted that the following describes the process for detecting the actual attitudes of the vehicle-mounted cameras 11a to 11d (at S212).

When the actual attitudes of the vehicle-mounted cameras 11a to 11d are detected (at S212), the camera attitude detection process illustrated in FIG. 5 is terminated. In the synthesized image display process (illustrated in FIG. 2) to be executed after the actual attitudes of the vehicle-mounted cameras 11a to 11d being detected, the viewpoint conversion process corresponding to the actual attitudes of the vehicle-mounted cameras 11a to 11d detected at the process of S212 is carried out (at S104 illustrated in FIG. 2).

When it is determined that the actual attitudes of the vehicle-mounted cameras 11a to 11d have not been changed over the predetermined amount at the determination process at S210 (S210: no), since it is not needed to detect the actual attitudes of the vehicle-mounted cameras 11a to 11d, the camera attitude detection process illustrated in FIG. 5 is terminated without processing the process of S212.

As described above, since the driving support apparatus 10 in the present embodiment detects the actual attitudes of the vehicle-mounted cameras 11a to 11d based on the detection results of the height sensors 12a to 12d, the actual attitudes of the vehicle-mounted cameras 11a to 11d varied with the “carrying load” applied to the vehicle 1 can be detected. Since the viewpoint conversion process corresponding to the actual attitudes of the vehicle-mounted cameras 11a to 11d is carried out, the offset occurred in the image at the junction of the bird's eye view images can be eliminated.

When all of the doors and trunk of the vehicle 1 are locked, the driving support apparatus 10 of the present embodiment estimates the “carrying load”, that is, the actual attitudes of the vehicle-mounted cameras 11a to 11d being confirmed and detects the actual attitudes of the vehicle-mounted cameras 11a to 11d. Accordingly, since the actual attitudes of the vehicle-mounted cameras 11a to 11d can be detected at the timing where the actual attitudes of the vehicle-mounted cameras 11a to 11d are confirmed, the processing load on the controller 13 can be lessen, and the offset in the image at the junction of the bird's eye view images caused by a change in attitudes of the vehicle-mounted cameras 11a to 11d can be properly eliminated.

For convenience, the description above with the use of FIGS. 3 and 4 illustrates that the images with the lane mark being filmed are taken by the vehicle-mounted cameras 11b to 11d. However, with regard to the driving support apparatus 10, it is not necessary to film a specific target object such as a lane mark in the image.

The above describes the process (S200: no) when the load confirmation flag is not set at ON, in other words, the “carrying load” has not been confirmed in the determination process at S200. In contrast, when the load confirmation flag is set at ON, in other words, the “carrying load” has been confirmed (S200: yes), the opening or closing detector 14 firstly reads out the information (opening/closing information) about whether the doors or trunk of the vehicle 1 are open or not (at S214). Subsequently, it is determined whether at least one of the doors or trunk of the vehicle 1 is open based on the opening/closing information (at S216).

As a result, when at least one of the doors and trunk is open (S216: yes), the load confirmation flag is set at OFF (at S218).

Even if the “carrying load” is once confirmed (or it is estimated to be confirmed), it is possible to have a change in “carrying load” when the passengers get off the vehicle as the door is open again or when the baggage is unloaded as the trunk is open again. (Alternatively, as the attitude of the vehicle 1 changes, the actual attitudes of the vehicle-mounted cameras 11a to 11d also change.) Therefore, when at least one of the doors and the trunk of the vehicle 1 is open (S216: yes), the load confirmation flag is set at OFF as the “carrying load” has not been confirmed until all of the doors and trunk of the vehicle 1 are locked (at S218).

When the load confirmation flag is set at OFF (at S218), the camera attitude detection process illustrated in FIG. 5 is terminated. In a situation where the load confirmation flag is set at OFF as described above, when the camera attitude detection process illustrated in FIG. 5 is carried out next; and when it is determined that the above processes in S204 to S212 are carried out when it is determined that the “carrying load” has not been confirmed in the process of S200 (S200: no). That is, the actual attitudes of the vehicle-mounted cameras 11a to 11d when the “carrying load” is confirmed as all of the doors and the trunk of the vehicle 1 are locked. Subsequently, in the synthesized image display process (illustrated in FIG. 2) to be executed after the actual attitudes of the vehicle-mounted cameras 11a to 11d, the viewpoint conversion process corresponding to the detected actual attitudes of the vehicle-mounted cameras 11a to 11d is carried out (at S104 in FIG. 2).

When it is determined that all of the doors and trunk of the vehicle 1 are still locked at the determination process at S216 (S216: no), since there is no change in “carrying load”, the load confirmation flag is still set at ON (omitting the process at S218) and the camera attitude detection process illustrated in FIG. 5 is terminated.

As described above, even when the actual attitude of the vehicle-mounted camera is once detected, the driving support apparatus 10 of the present embodiment estimates that there is a change in “carrying load”, that is, the actual attitudes of the vehicle-mounted cameras 11a to 11d, and detects and corrects the actual attitudes of the vehicle-mounted cameras 11a to 11d when any of the doors and the trunk of the vehicle 1 is open and then locked again. Accordingly, since the attitude can be detected at the timing where there are changes in the actual attitudes of the vehicle-mounted cameras 11a to 11d, it is possible to reduce processing burden on the controller 13 and eliminate offset in an image at the junction of the bird's eye view image.

B-3. Detection Method for the Actual Attitude of the Vehicle-Mounted Camera:

The following describes a method for detecting (or computing) the actual attitudes of the vehicle-mounted cameras 11a to 11d based on the vehicle heights detected by the height sensors 12a to 12d. In other words, the following describes the content of S212 in the camera attitude detection process illustrated in FIG. 5.

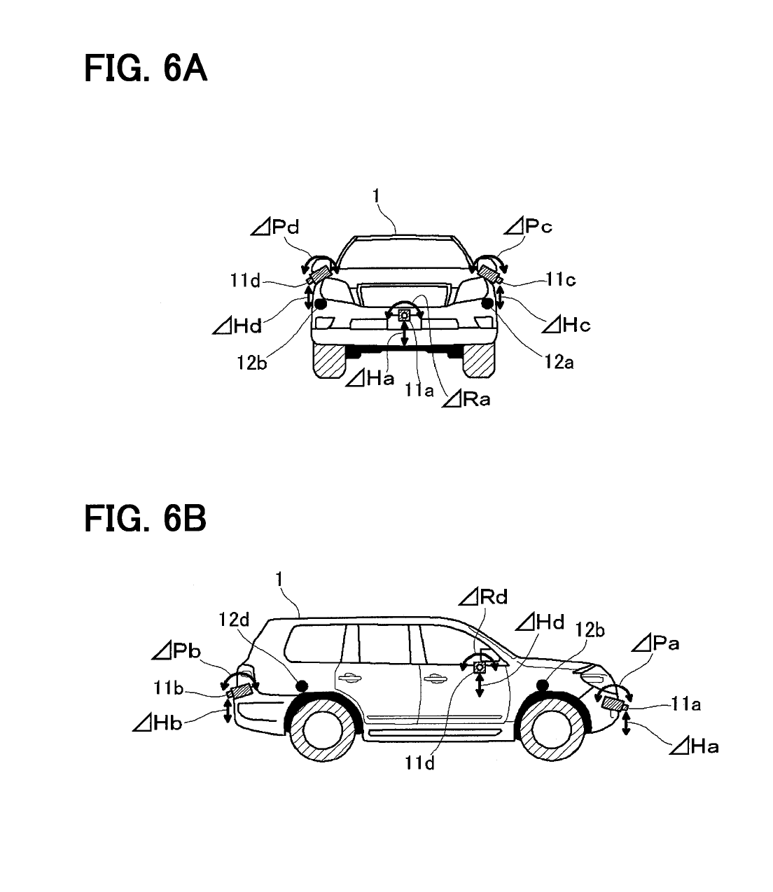

The driving support apparatus 10 of the present embodiment detects a roll changing amount, pitch changing amount and vertical position changing amount from the attitudes prior to delivery as the actual attitudes of a variety of vehicle-mounted cameras 11a to 11d. In other words, as shown in FIGS. 6A and 6B, when the vehicle-mounted cameras 11a and 11b are provided at the front and rear of the vehicle, the changing amount (ΔPa, ΔPb) in rotational angle (pitch) given that the left-right direction of the vehicle 1 is set as an axis; the changing amount (ΔRa, ΔRb (not shown)) in rotational angle (roll) given that the front-rear direction of the vehicle 1 is set as an axis; and the changing amount in vertical position (ΔHa, ΔHb), are detected. Additionally, when the vehicle-mounted cameras 11c and 11d are provided at the left and right of the vehicle, the changing amount (ΔPc, ΔPd) in rotational angle (pitch) given that the front-rear direction of the vehicle 1 is set as an axis; the changing amount (ΔRc (not shown), ΔRd) in rotational angle (roll) given that the left-right direction of the vehicle 1 is set as an axis; and the changing amount in vertical position (ΔHc, ΔHd), are detected. It is noted that a variety of methods may be adopted as a method for detecting these changing amounts.

The following firstly shows an example of a method for detecting the changing amount in roll and changing amount in pitch by a variety of the vehicle-mounted cameras 11a to 11d.

B-3-1. Method for Detecting Changing Amount in Roll and Changing Amount in Pitch of the Vehicle-Mounted Camera:

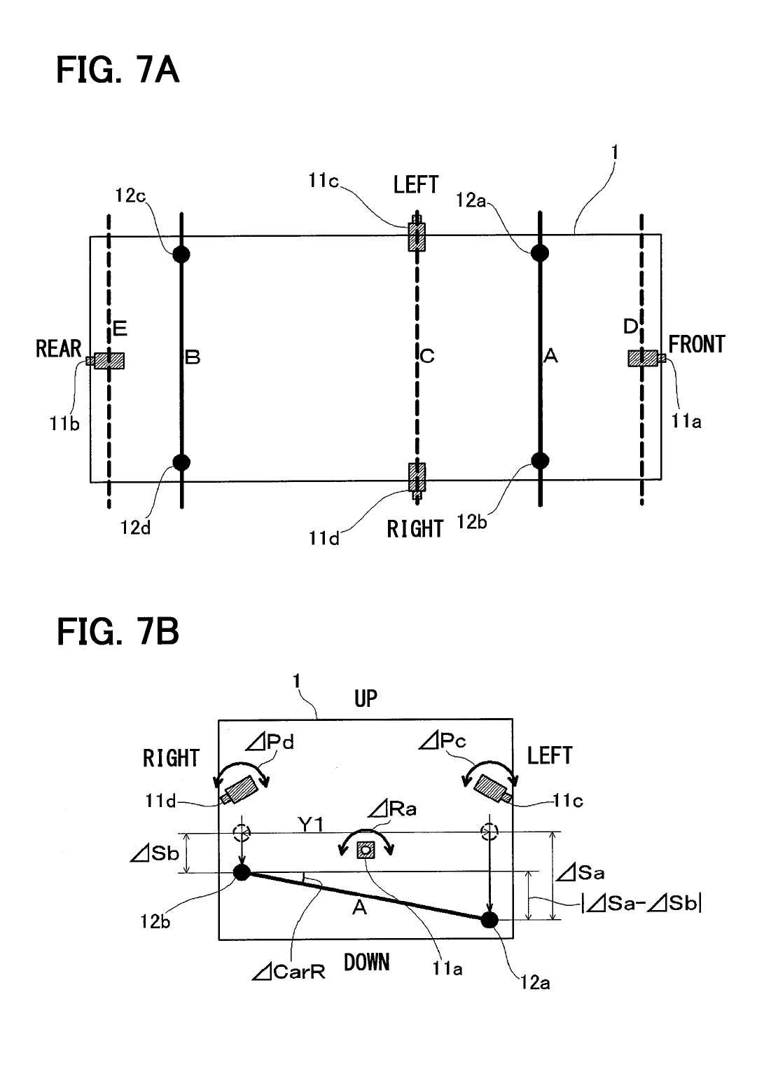

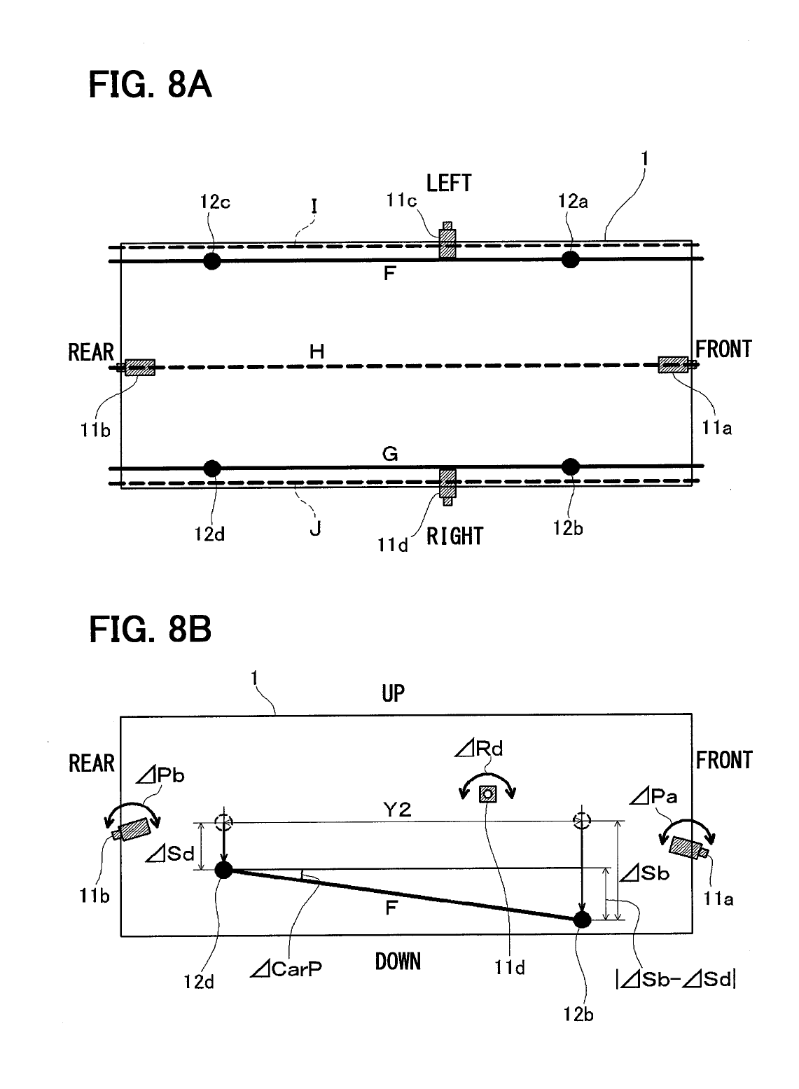

FIGS. 7A, 7B and FIGS. 8A, 8B conceptually illustrate the method for detecting the changing amount in roll and the changing amount in pitch of the vehicle-mounted cameras 11a to 11d. For easier understanding of these drawings, the vehicle 1 is illustrated in a rectangular shape for simplicity in FIGS. 7A, 7B and FIGS. 8A, 8B.

When the vehicle 1 is interpreted as a rigid body, the changing amount in pitch of a virtual axis A passing through the height sensors 12a and 12b (or a virtual axis B passing through the height sensors 12c and 12d) illustrated in FIG. 7A is identical to the changing amount in pitch of a virtual axis C passing through the vehicle-mounted cameras 11c and 11d. Accordingly, the changing amount in pitch (ΔPc, ΔPd) of the vehicle-mounted cameras 11c, 11d can be calculated through the calculation of the changing amount in pitch of the virtual axis A (or virtual axis B).

Similarly, the changing amount in pitch of a virtual axis A passing through the height sensors 12a and 12b (or a virtual axis B passing through the height sensors 12c and 12d) is identical to the changing amount in pitch of a virtual axis D passing through the vehicle-mounted camera 11a. In addition, the changing amount in pitch of the virtual axis A (or virtual axis B) is identical to the changing amount in pitch of the virtual axis E passing through the vehicle-mounted camera 11b. Accordingly, the changing amount in roll (ΔRa, ΔRb) of the vehicle-mounted cameras 11a, 11b can be calculated through the calculation of changing amount in pitch of the virtual axis A (or the virtual axis B). It is noted that the changing amount in pitch of the virtual axis A (or the virtual axis B) is also the changing amount of roll of the vehicle 1 itself (the attitude of the vehicle), therefore, the following assigns the changing amount as ΔCarR.

As shown in FIG. 7B, the changing amount in pitch of the virtual axis A (or the virtual axis B) (also as the changing amount in roll of the vehicle 1 itself ΔCarR) can be evaluated in the following formula by using the distance (Y1) between left and right height sensors 12a-12b (or 12c-12d) in a left-right direction, the changing amount in vehicle height (ΔSa) detected by the height sensor 12a, and the changing amount in vehicle height (ΔSb) detected by the height sensor 12b.

ΔCarR=arctan(Y1/|ΔSa−ΔSb|) (1)

The changing amount in pitch (the changing amount in roll of the vehicle 1 itself ΔCarR) of the virtual axis A (or the virtual axis B) evaluated as above is represented by the changing amount in pitch (ΔPc, ΔPd) of the vehicle-mounted cameras 11c, 11d and the changing amount in roll of the vehicle-mounted cameras 11a, 11b (ΔRa, ΔRb).

When the vehicle 1 is interpreted as a rigid body, the changing amount in pitch of a virtual axis F passing through the height sensors 12a and 12c (or a virtual axis G passing through the height sensors 12b and 12d) illustrated in FIG. 8A is identical to the changing amount in pitch of a virtual axis H passing through the vehicle-mounted cameras 11a and 11b. Accordingly, the changing amount in pitch (ΔPa, ΔPb) of the vehicle-mounted cameras 11a, 11b can be calculated through the calculation of the changing amount in pitch of the virtual axis F (or virtual axis G).

Similarly, the changing amount in pitch of a virtual axis F passing through the height sensors 12a and 12c (or a virtual axis G passing through the height sensors 12b and 12d) is identical to the changing amount in pitch of a virtual axis I passing through the vehicle-mounted camera 11c. In addition, the changing amount in pitch of the virtual axis F (or virtual axis G) is identical to the changing amount in pitch of the virtual axis J passing through the vehicle-mounted camera 11d. Accordingly, the changing amount in roll (ΔRc, ΔRd) of the vehicle-mounted cameras 11c, 11d can be calculated through the calculation of changing amount in pitch of the virtual axis F (or the virtual axis G). It is noted that the changing amount in pitch of the virtual axis F (or the virtual axis G) is also the changing amount of roll of the vehicle 1 itself (the attitude of the vehicle), therefore, the following assigns the changing amount as ΔCarP.

As shown in FIG. 8B, the changing amount in pitch of the virtual axis F (or the virtual axis G) (also as the changing amount in roll of the vehicle 1 itself ΔCarP) can be evaluated in the following formula by using the distance (Y1) between front and rear height sensors 12b-12d (or 12a-12c) in a front-rear direction, the changing amount in vehicle height (ΔSb) detected by the height sensor 12b, and the changing amount in vehicle height (ΔSd) detected by the height sensor 12d.

ΔCarP=arctan(Y2/|ΔSb−ΔSd|) (2)

The changing amount in pitch (the changing amount in roll of the vehicle 1 itself ΔCarP) of the virtual axis F (or the virtual axis G) evaluated as above is represented by the changing amount in pitch (ΔPa, ΔPb) of the vehicle-mounted cameras 11a, 11b and the changing amount in roll of the vehicle-mounted cameras 11c, 11d (ΔRc, ΔRd).

When the vehicle 1 is not a rigid body, it is possible that the calculated results obtained by the above formulas (1) and (2) are not identical to the roll or pitch of the vehicle-mounted cameras 11a to 11d. That is, when the vehicle 1 changes in shape caused by load, torsion occurs so that it is possible the pitch of the virtual axis A (or the virtual axis B) is not identical to the pitch of the virtual axes C to E. In this situation, the pitch of the virtual axis A (or the virtual axis B) is different from the changing amount in pitch of the vehicle-mounted cameras 11c, 11d (ΔPc, ΔPd) and the changing amount in roll of the vehicle-mounted cameras 11a, 11b (ΔRa, ΔRb). Similarly, when the vehicle 1 changes in shape caused by load, torsion occurs so that it is possible the pitch of the virtual axis F (or the virtual axis G) is not identical to the pitch of the virtual axes H to J. In this situation, the pitch of the virtual axis F (or the virtual axis G) is different from the changing amount in pitch of the vehicle-mounted cameras 11a, 11b (ΔPa, ΔPb) and the changing amount in roll of the vehicle-mounted cameras 11c, 11d (ΔRc, ΔRd).

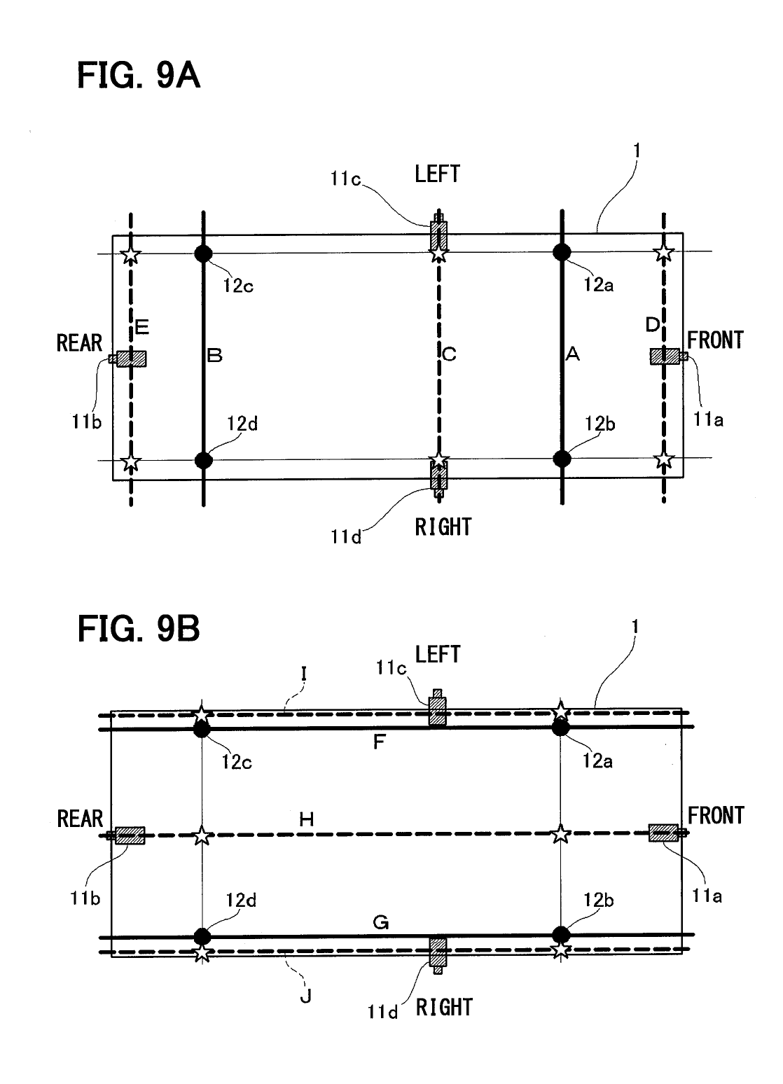

When the vehicle 1 is not a rigid body, as shown in FIGS. 9A and 9B, the changing amount in vehicle height at the specific positions (shown as the mark ⋆ in the drawing) on each of the virtual axes C to E and H to J passing through the vehicle-mounted cameras is estimated, and then the pitch of each of the virtual axes C to E, and H to J is directly calculated. Subsequently, the pitch of each of the virtual axes C to E and H to J directly calculated above is assigned as the roll or pitch of the vehicle-mounted cameras 11a to 11d in approximation.

That is, the changing amount in the vehicle height detected by each of the height sensors 12a to 12d and the changing amount in the vehicle height at each specific position based on the distance (in a horizontal direction) between each of the height sensors 12a to 12d and each of the specific position (shown as the mark ⋆ in the drawing). Then, Y1 and Y2 in the formulas (1) and (2) are switched to the “distance (in horizontal direction) between specific positions on the same virtual axis”; ΔSa, ΔSb, and ΔSd are switched to the “changing amount in the vehicle heights at the respective specific positions”; the pitch of each of the virtual axes C to E and H to J; and the calculated pitch of each of the virtual axes C to E and H to J is assigned as the roll or pitch of the vehicle-mounted cameras 11a to 11d in approximation.

When the vehicle 1 is interpreted not to be a rigid body, other than the above method, the method for calculating the pitch of the virtual axes C to E in approximation based on the pitch of the virtual axis A, B and the distances from the virtual axes A, B to the virtual axes C to E may be used; or alternatively, the method for calculating the pitch of the virtual axes H to I in approximation based on the pitch of the virtual axis F, G and the distances from the virtual axes F, G to the virtual axes H to J may be used.

B-3-2. Method for Detecting the Changing Amount in Vertical Position of the Vehicle-Mounted Camera:

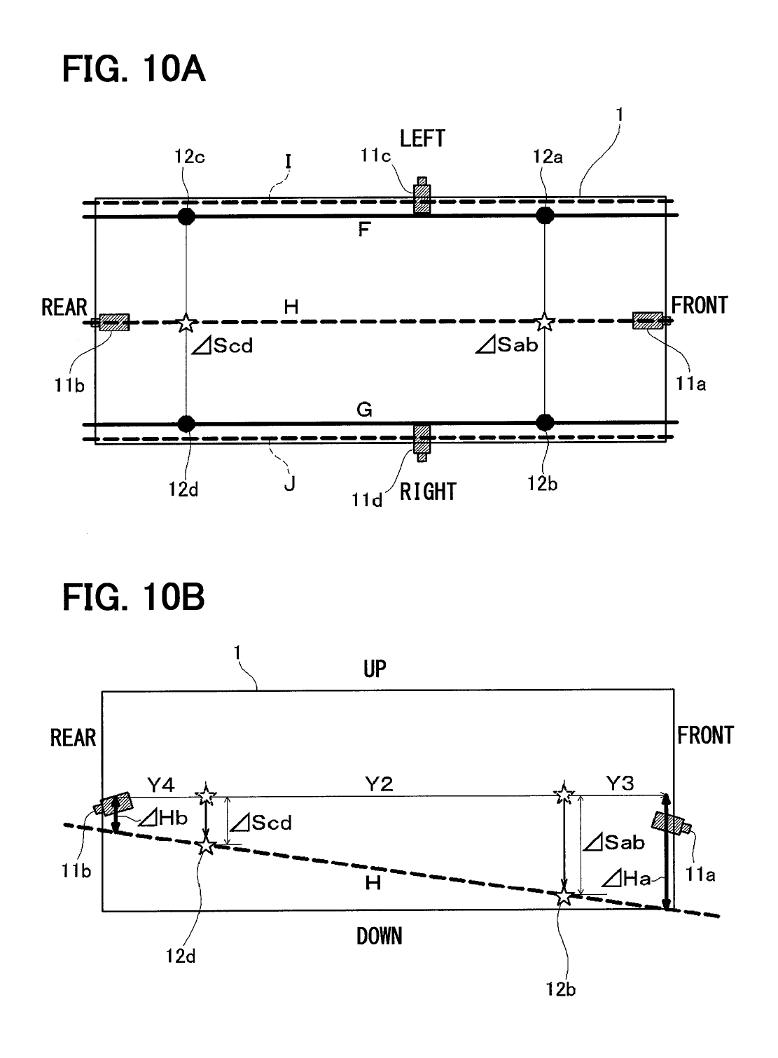

FIGS. 10A and 10B conceptually illustrate the method for detecting the changing amount ΔHa, ΔHb in the vertical position of the front and rear vehicle-mounted cameras 11a and 11b. When the changing amount of the vertical position of the front and rear vehicle-mounted cameras 11a, 11b is detected, the “changing amounts ΔSab, ΔScd in vertical positions” at a plurality of specific positions on the “virtual axis H passing through the front and rear vehicle-mounted cameras 11a, 11b” are firstly calculated as shown in FIG. 10A. Herein, the positions (or coordinates) in a front-rear direction on the virtual axis H are set as the specific positions identical to the locations of the height sensors 12a, 12b; and the positions (or coordinates) in a front-rear direction on the virtual axis H are set as the specific positions identical to the locations of the height sensors 12c, 12d. Subsequently, the changing amount in vertical position of the specific position can be calculated based on the positional relation between the vehicle-mounted cameras 11a, 11b and the height sensors 12a to 12d in a left-right direction. For example, in a left-right direction, when the vehicle-mounted camera 11a is at the middle between the height sensors 12a and 12b, the changing amount ΔSab in vertical position at the specific position can be calculated as the average of the detection results of the height sensors 12a, 12b.

When the “changing amounts in vehicle height ΔSab, ΔScd” at a plurality of specific positions (shown as the mark ⋆ in the drawing) on the “virtual axis H passing through the front and rear vehicle-mounted cameras 11a, 11b” are calculated, the changing amount (shown in a thick line in the drawing) in vehicle height of the positions corresponding to the vehicle-mounted cameras 11a, 11b at the virtual axis H (that is, the changing amount in vertical position ΔHa, ΔHb) is calculated. The changing amount is obtained by using an approximated relation; and using the distance in a front-rear direction Y2 between the height sensors 12b-12d (or between the height sensors 12a-12c), the distance in a front-rear direction Y3 from the vehicle-mounted camera 11a to the height sensor 12b (or the height sensor 12a), and the distance in a front-back direction Y4 from the vehicle-mounted camera 11b to the height sensor 12d (or the height sensor 12c), based on the approximated relation. That is, for example, with regard to the example illustrated in FIG. 10B, the changing amount can be calculated by the following formulas (3) and (4).

ΔHa=ΔScd+((Y2+Y3)(ΔSab−ΔScd))/Y2 (3)

ΔHb=ΔScd−F(Y4(ΔSab−ΔScd))/Y2 (4)

For the changing amounts ΔHc and ΔHd in vertical position of the left and right vehicle-mounted cameras 11c, 11d, the calculation for these values is similar to the calculation for the above-mentioned front and rear vehicle-mounted cameras 11a, 11b.

As described above, the driving support apparatus 10 in the present embodiment detects the changing amount in roll, changing amount in pitch and changing amount in vertical position from the attitude before delivery as the actual attitude of each of the vehicle-mounted cameras 11a to 11d.

### C. Modification Example

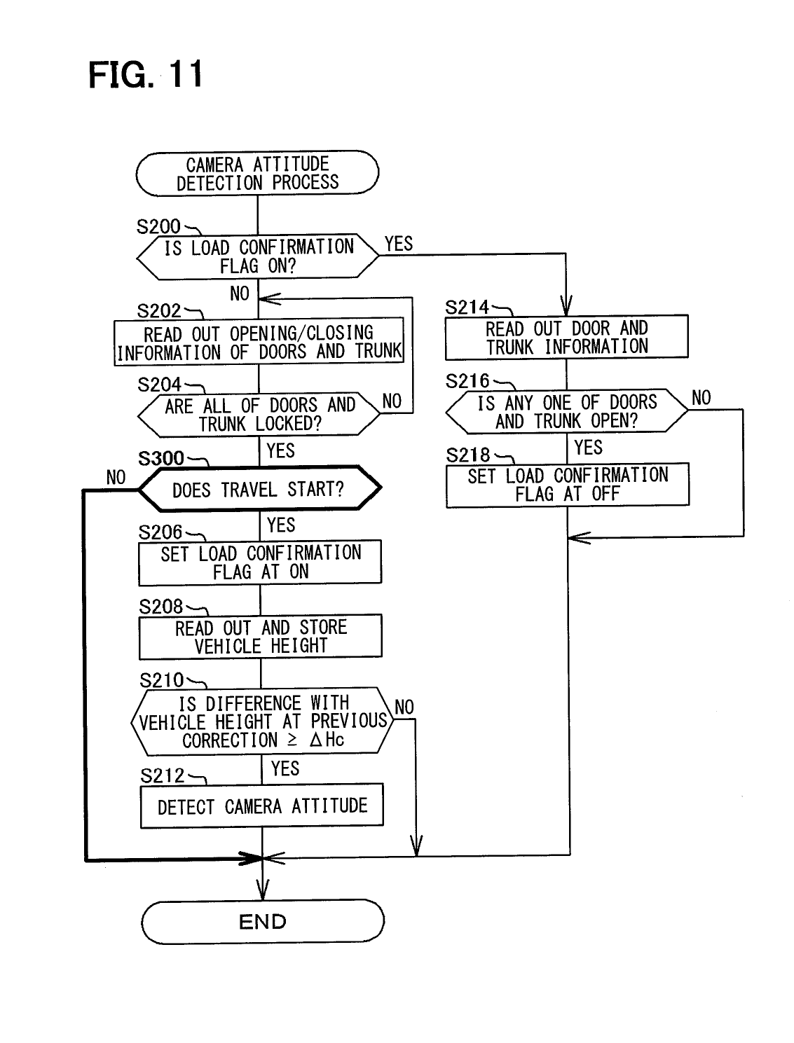

FIG. 11 illustrates a flowchart of the camera attitude detection process in the modification example. With regard to the camera attitude detection process in the modification example, the process at S300 in FIG. 11 is added to the camera attitude detection process (illustrated in FIG. 5) in the above embodiment. In other words, in the above embodiment, the load (carrying load) applied to the vehicle 1 is confirmed after all of the doors and trunk are locked, the actual attitudes of the vehicle-mounted cameras 11a to 11d are detected. In contrast, in the modification example, when all of the doors and trunk are locked; and when the vehicle 1 starts travelling (S300: yes), the load (carrying load) applied to the vehicle 1 is confirmed and then the actual attitudes of the vehicle-mounted cameras 11a to 11d are detected. Therefore, the effect described in the following can be achieved.

Even if all of the doors and trunk are locked, it is still possible that the load applied to the vehicle 1 has not been confirmed as the passenger's boarding and load carrying have not been completed yet. Even if the load applied to the vehicle 1 has not been confirmed as described above, when the actual attitudes of the vehicle-mounted cameras 11a to 11d is detected as all of the doors and trunk are locked, it is possible to enlarge processing burden on the controller 13. When the vehicle 1 starts travelling, it can be estimated that there is a higher possibility that the load applied to the vehicle 1 is confirmed as the passenger's boarding or load carrying is complete. When all of the doors and trunk are locked and when the vehicle 1 starts travelling, when the actual attitudes of the vehicle-mounted cameras 11a to 11d are detected, since there is a higher possibility that the load applied to the vehicle 1 is confirmed so that the actual attitudes of the vehicle-mounted cameras 11a to 11d are detected. Accordingly, the processing load on the controller 13 can be further reduced.

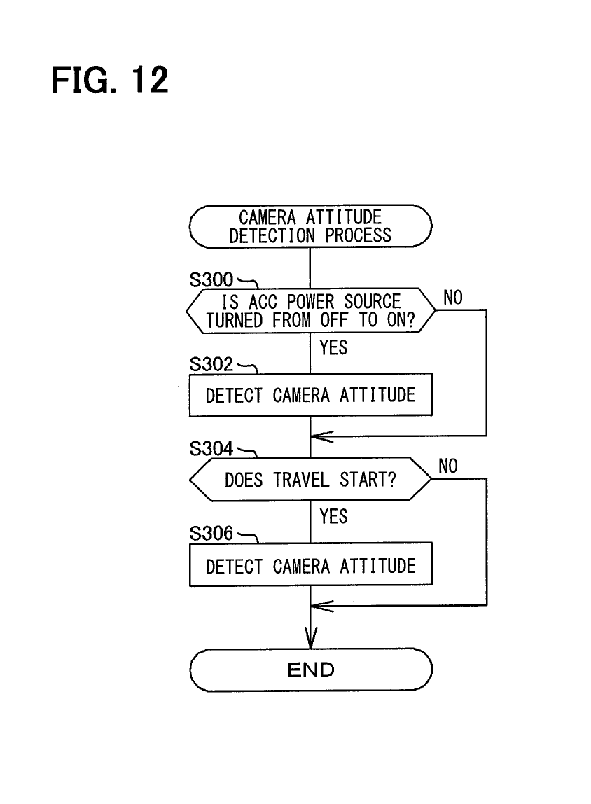

In addition to the camera attitude detection processes in both of the above embodiment and the modification example, the camera attitude detection process as illustrated in FIG. 12 may be carried out. In other words, when the ACC power source is turned on (S300: yes); or when the vehicle 1 starts travelling regardless of the locking of all of the doors and trunk (S304: yes), the actual attitudes of the vehicle-mounted cameras 11a to 11d may be detected (at S302, S306). Thus, the actual attitudes of the vehicle-mounted cameras 11a to 11d can be further detected.

The above describes the driving support apparatus in the embodiment and the modification example; however, the present disclosure is not only limited to the above embodiment and the modification example. The present disclosure is intended to cover various modification within the spirit and scope of the present disclosure.

For example, for the calculation method of the actual attitudes of the vehicle-mounted cameras 11a to 11d, a variety of methods may be adopted other than the method described in the above embodiment. For example, the calculation process can be simplified by providing the height sensors at the locations identical to the vehicle-mounted cameras 11a to 11d (setting the values of the height sensors as the changing amounts in vertical position of the vehicle-mounted cameras 11a to 11d).

In the above embodiment and the modification example, the camera attitude detector 16 estimates that the load applied to the vehicle 1 is confirmed and the actual attitudes of the vehicle-mounted cameras 11a to 11d are detected, when all of the doors and trunk are locked; or alternatively, when all of the doors and trunk are locked and the vehicle 1 starts travelling. However, it is not limited to the above situation. The camera attitude detector 16 may detect the actual attitudes of the vehicle-mounted cameras 11a to 11d only when the vehicle 1 starts travelling.

Moreover, the camera attitude detector 16 estimates that the load applied to the vehicle 1 is confirmed and may detect the actual attitudes of the vehicle-mounted cameras 11a to 11d, when a brake pedal which has been stepped returns to a situation prior to the stepping of the brake pedal; or when a hand brake is released. In this type of situation, since it can be estimated that the brake is released just before the travel starts, there is a lower possibility that the passenger boards on the vehicle and the baggage is carried; or there is a higher possibility that the load applied to the vehicle 1 is confirmed. Therefore, when it is assumed that the actual attitudes of the vehicle-mounted cameras 11a to 11d is detected as the brake is released, since the actual attitudes of the vehicle-mounted cameras 11a to 11d can be detected because the possibility of the load applied to the vehicle 1 is getting higher, it is possible that the processing load on the controller 13 can be further reduced.

The above-mentioned embodiment and the modification example are configured to execute driving support by displaying a synthesized image, which links bird's eye view images together. However, it is not limited to this situation. The image taken by the vehicle-mounted camera is corrected based on the actual attitude of the vehicle-mounted camera (or the vehicle), and the positional relation between the vehicle and the lane mark may also be detected based on the corrected image. It also may be configured to execute driving support by monitoring lane departure of the vehicle based on the positional relation between the vehicle and the lane mark; outputting a warning notification as the lane departure is detected; and automatically controlling steering. In addition, the image taken by the vehicle-mounted camera is corrected based on the actual attitude of the vehicle-mounted camera (or the vehicle) and the positional relation between the vehicle and an obstacle may be detected based on the corrected image. Then, it is configured to execute driving support by monitoring the obstacle getting closer to the vehicle based on the positional relation between the vehicle and the obstacle; outputting a warning notification as it is detected that the obstacle is getting closer; and automatically controlling the brake.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

1. A driving support apparatus arranged at a vehicle attached with a vehicle-mounted camera at a predetermined angle to execute driving support based on an image taken by the vehicle-mounted camera, the apparatus comprising:
a height sensor that is individually attached at left and right of a front part of the vehicle and at left and right of a rear part of the vehicle, and detects a vehicle height at a location where the height sensor is attached;
an attitude detector that detects an attitude of the vehicle based on a detection result of the height sensor;
an acquisition device that acquires the image taken by the vehicle-mounted camera;
a correction device that corrects the image acquired by the acquisition device based on the attitude of the vehicle detected by the attitude detector; and
an execution device that executes the driving support based on the image corrected by the correction device.

2. The driving support apparatus according to claim 1, further comprising:
one or a plurality of vehicle-mounted cameras, wherein:
the correction device converts one or a plurality of images respectively taken by the one or the plurality of vehicle-mounted cameras to one or a plurality of bird's eye view images of the vehicle viewed from above in consideration of the attitude of the vehicle; and
the execution device displays the one or the plurality of bird's eye view images.

3. The driving support apparatus according to claim 1,
wherein the attitude detector detects the attitude of the vehicle when a door and a trunk of the vehicle are locked.

4. The driving support apparatus according to claim 1,
wherein the attitude detector detects the attitude of the vehicle when a brake pedal, on which has been stepped, returns to a state prior to the brake pedal being stepped.

5. The driving support apparatus according to claim 1,
wherein the attitude detector detects the attitude of the vehicle when a hand brake is released.

6. The driving support apparatus according to claim 1,
wherein the attitude detector detects the attitude of the vehicle when the vehicle starts travelling.

7. A driving support method executing driving support based on an image taken by a vehicle-mounted camera attached to a vehicle at a predetermined angle, the method comprising:
detecting an attitude of the vehicle based on a detection result of a height sensor individually attached at left and right of a front part of the vehicle and at left and right of a rear part of the vehicle;
acquiring an image taken by the vehicle-mounted camera;
correcting the acquired image based on the attitude of the vehicle; and
executing driving support based on the corrected image.

8. An image correction apparatus arranged at a vehicle attached with a vehicle-mounted camera at a predetermined angle to correct an image taken by the vehicle-mounted camera, the apparatus comprising:
a height sensor that is individually attached at left and right of a front part of the vehicle and at left and right of a rear part of the vehicle and detects a vehicle height at a location where the height sensor is attached;
an attitude detector that detects an attitude of the vehicle based on a detection result of the height sensor;
an acquisition device that acquires an image taken by the vehicle-mounted camera; and
a correction device that corrects the image acquired by the acquisition device based on the attitude of the vehicle detected by the attitude detector.

9. An image correction method correcting an image taken by a vehicle-mounted camera attached to a vehicle at a predetermined angle, the method comprising:
detecting an attitude of the vehicle based on a detection result of a height sensor individually attached at left and right of a front part of the vehicle and at left and right of a rear part of the vehicle;
acquiring the image taken by the vehicle-mounted camera; and
correcting the acquired image based on the attitude of the vehicle.

10. A driving support apparatus arranged at a vehicle attached with a vehicle-mounted camera at a predetermined angle to execute driving support based on an image taken by the vehicle-mounted camera, the apparatus comprising:
a height sensor that is individually attached at a plurality of locations of the vehicle, and detects a vehicle height at a location where the height sensor is attached;
an attitude detector that detects an attitude of the vehicle based on a detection result of the height sensor;
an acquisition device that acquires the image taken by the vehicle-mounted camera;
a correction device that corrects the image acquired by the acquisition device based on the attitude of the vehicle detected by the attitude detector; and
an execution device that executes the driving support based on the image corrected by the correction device.

11. An image correction apparatus arranged at a vehicle attached with a vehicle-mounted camera at a predetermined angle to correct an image taken by the vehicle-mounted camera, the apparatus comprising:
a height sensor that is individually attached at a plurality of locations of the vehicle and detects a vehicle height at a location where the height sensor is attached;
an attitude detector that detects an attitude of the vehicle based on a detection result of the height sensor;
an acquisition device that acquires an image taken by the vehicle-mounted camera; and
a correction device that corrects the image acquired by the acquisition device based on the attitude of the vehicle detected by the attitude detector.
